(19) United States
(12) Patent Application Publication
(10) Pub. No.: US 2007/0147552 A1
(43) Pub. Date: Jun. 28, 2007

(54) METHOD AND APPARATUS FOR DETECTING TRANSMISSION OF A PACKET IN A WIRELESS COMMUNICATION SYSTEM

(75) Inventors: Robert L. Olesen, Huntington, NY (US); I-Tai Lu, Dix Hills, NY (US); Yongwen Yang, Hillsborough, NJ (US); KunJu Tsai, Forest Hills, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/609,519

(22) Filed: Dec. 12, 2006

Related U.S. Application Data
(60) Provisional application No. 60/751,331, filed on Dec. 16, 2005.

(51) Int. Cl. H04L 27/06

(52) U.S. Cl. 375/343

(57) ABSTRACT

A method and apparatus for detecting transmission of a packet in a wireless communication system are disclosed. A packet includes a preamble which comprises multiple repetition of a training sequence. A signal is detected and the detected signal is correlated with a delayed version of the detected signal which is delayed by a predetermined delay time to generate a sequence of correlations. The correlations are normalized. A difference between a first normalized correlation and a second normalized correlation that are separated by the predetermined delay time is calculated. The difference is compared to a threshold. A transmission of the packet is detected based on the comparison. The first and second normalized correlations may be averaged over first and second averaging periods, respectively. A point generating a maximum difference may be identified, and packet synchronization may be performed based on the identified point.

### CROSS REFERENCE TO RELATED APPLICATION

This application claims the benefit of U.S. Provisional Application No. 60/751,331 filed Dec. 16, 2005, which is incorporated by reference as if fully set forth.

### FIELD OF INVENTION

The present invention is related to wireless communication systems. More particularly, the present invention is related to a method and apparatus for detecting transmission of a packet in a wireless communication system.

### BACKGROUND

Synchronization is an essential task for any digital communication system. Without accurate synchronization, it is not possible to reliably receive a transmitted packet. For packet switched networks, the synchronization has to be achieved during a very short time after the start of an incoming packet. To facilitate fast synchronization, under the current wireless local area network (WLAN) standards, such as IEEE 802.11a/g/n, a preamble is included in the beginning of each packet. The length and contents of the preamble are carefully designed to provide enough information for signal detection and synchronization without any unnecessary overhead.

An IEEE 802.11a/g/n WLAN system is essentially a random access system, in which a receiver does not know exactly when a packet starts. The first task of the receiver is to detect a signal and the start of an incoming packet. Generally, the signal detection can be performed as a binary hypothesis test where a decision variable is compared to a threshold. If the decision variable is smaller than the threshold, it is determined that a packet is not present in the signal. If the decision variable is greater than or equal to the threshold, it is determined that a packet is present in the signal.

FIG. 1 is a functional block diagram of a conventional detector 100. The conventional detector 100 is a delay and correlator type detector. The detector 100 includes a delay unit 102, a complex conjugate unit 104, a multiplier 106, an integration unit 108, a magnitude square unit 110, a divider 116, an auto-correlation unit 112 and a square unit 114. The conventional detector 100 takes advantage of the periodicity of short training sequences at the start of an IEEE 802.11a/g/n preamble 202. FIG. 2 shows an exemplary packet 200 including the preamble 202. The preamble 202 includes a short training sequence (t₁-t₁₀) and a long training sequence (T₁, T₂). The short training sequence is repeated ten (10) times and the long training sequence is repeated two (2) times.

Referring to FIG. 1, a received signal 101 is delayed by the delay unit 102 by a predetermined period of time, (e.g., 0.8 μs), and a complex conjugate of the delayed signal 103 is generated by the complex conjugate unit 104. The received signal 101 and the complex conjugate 105 of the delayed received signal 103 are multiplied by the multiplier 106. The multiplied result is integrated over a first sliding window by the integration unit 108 to generate a cross-correlation 109. A magnitude square 111 of the cross-correlation 109 is calculated by the magnitude square unit 110.

The delayed received signal 103 is also processed by the auto-correlation unit 112 to compute a signal energy value 113 over a second sliding window. The signal energy value 113 is squared by the square unit 114. A normalized correlation is then computed using the divider 116 which divides the cross-correlation magnitude square 111 with the squared signal energy value 115. The normalized correlation 117 is compared to a threshold to determine a presence of a transmitted packet.

As mentioned above, there are two sliding windows used in the conventional detector 100 of FIG. 1. The first sliding window is for calculating the cross-correlation between the received signal 101 and the delayed received signal 103. The second sliding window is for calculating the received signal energy. The calculated received signal energy is used to normalize the cross-correlation, so that the cross-correlation is not dependent on an absolute received power level.

When signal strength is low, the noise variance contributes to the signal energy calculation significantly differently to the cross-correlation. Therefore, the signal detection decision variable is dependent to a signal-to-noise ratio (SNR) and the threshold should be set differently based on the SNR.

### SUMMARY

The present invention is related to a method and apparatus for detecting transmission of a packet in a wireless communication system. A packet includes multiple repetition of a training sequence. A signal is detected and the detected signal is correlated with a delayed version of the detected signal delayed by a predetermined delay time to generate a sequence of correlations. The correlations are normalized. A difference between a first normalized correlation and a second normalized correlation that are separated by the predetermined delay time is calculated. The difference is compared to a threshold. A transmission of the packet is detected based on the comparison. The first and second normalized correlations may be averaged over first and second averaging periods, respectively. A point generating a maximum difference may be identified, and packet synchronization may be performed based on the identified point.

### BRIEF DESCRIPTION OF THE DRAWINGS

FIG. 1 is a functional block diagram of a conventional detector.

FIG. 2 shows an exemplary frame including a preamble processed by the convention detector of FIG. 1.

FIG. 3 is a block diagram of an apparatus for detecting transmission of a packet in accordance with the present invention.

FIG. 4 shows typical correlation values calculated from the detected signals.

### DETAILED DESCRIPTION OF THE PREFERRED EMBODIMENTS

Hereafter, the terminology “wireless transmit/receive unit” (WTRU) includes but is not limited to a user equipment, a mobile station, a fixed or mobile subscriber unit, a pager, a cellular telephone, a personal digital assistant (PDA), a computer, or any other type of user device capable of operating in a wireless environment. When referred to hereafter, the terminology “access point” (AP) includes but is not limited to a Node-B, a base station, a site controller, or any other type of interfacing device capable of operating in a wireless environment.

The present invention may be implemented in a WTRU, a base station or a WLAN system at the physical layer in the radio and digital baseband. The implementation may be in the form of an application specific integrated circuit (ASIC), digital signal processor (DSP), middleware or hardware. The present invention is applicable to IEEE 802.11/16/20. The present invention may be implemented in a smart antenna, an enhanced uplink or orthogonal frequency division multiplexing (OFDM)/multiple-input multiple-output (MIMO) capable system, as well as a non-cellular system.

The features of the present invention may be incorporated into an integrated circuit (IC) or be configured in a circuit comprising a multitude of interconnecting components.

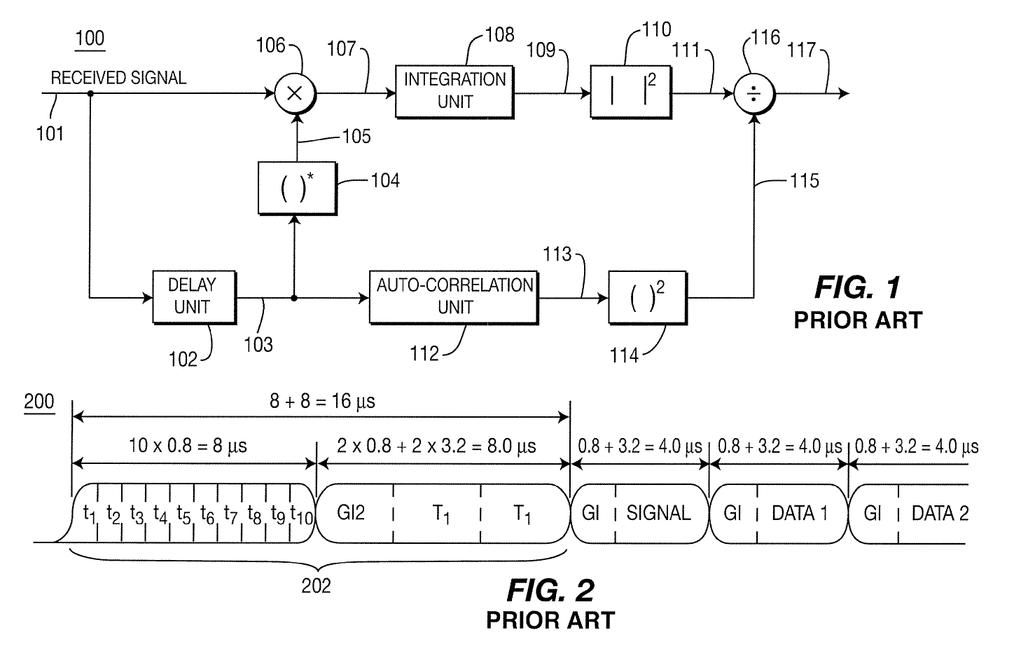

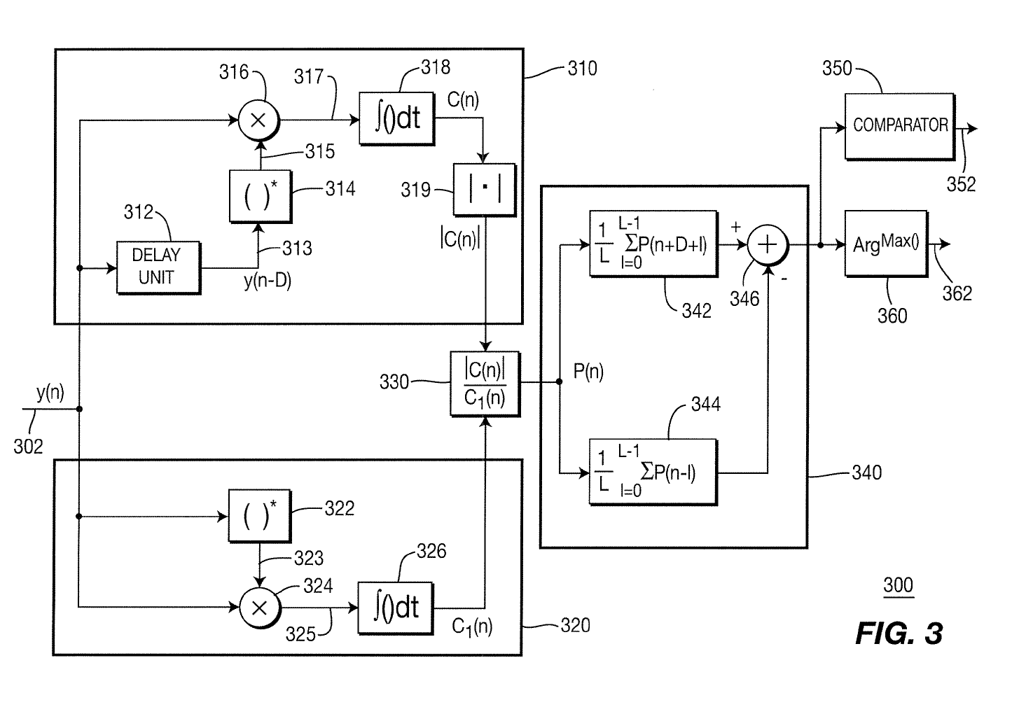

FIG. 3 is a functional block diagram of an apparatus 300 for detecting transmission of a packet in accordance with the present invention. The apparatus 300 is an improvement over the conventional detector 100 of FIG. 1. The apparatus 300 includes a correlation unit 310, a signal energy calculator 320, a divider 330, a difference calculator 340, a comparator 350 and a maximum identifier 360 (optional).

A variable, y(n), represents a signal 302 detected from each receive antenna (not shown). The detected signal 302 is fed to the correlation unit 310 and the signal energy calculator 320. The correlation unit 310 calculates correlations of detected signal and a delayed version of the detected signal. The correlation unit 310 may include a delay unit 312, a complex conjugate unit 314, a multiplier 316, an integrator 318 and a magnitude calculation unit 319. The delay unit 312 delays the detected signals 302 by a predetermined delay time, preferably of a duration of one training sequence (Tₛₗₒₜ). For example, in an IEEE 802.11a system, a 0.8 μs short training sequence, (i.e., 16 symbols), is repeated ten (10) times. Therefore, the delay time may be set to 0.8 μs, (i.e., 16 symbols). The complex conjugate unit 314 generates a complex conjugate of the delayed detected signal 313. The detected signal 302 and the complex conjugate 315 of the delayed detected signal 313 are then multiplied by the multiplier 316. The output 317 of the multiplier 316 is integrated by the integrator 318 over an integration interval to generate correlations, C(n). The integration interval may also be set to 0.8 μs. The magnitude of the correlations is computed by the magnitude calculation unit 319.

The signal energy calculator 320 calculates signal energy of the detected signal 302 for the correlation calculation interval, (e.g., 0.8 μs). The signal energy calculator 320 may include a complex conjugate unit 322, a multiplier 324 and an integrator 326. A complex conjugate 323 of the detected signals 302 is generated by the complex conjugate unit 322. The detected signals 302 and the complex conjugate 323 of the detected signals are multiplied by the multiplier 324. The output 325 of the multiplier 324 is then integrated by the integrator 326 over an integration interval to calculate signal energy, C₁(n), over the correlation calculation interval.

It should be noted that the configuration of the correlation unit 310 and the signal energy calculation unit 320 shown in FIG. 3 is provided as an example and any other configuration may be implemented.

The divider 330 divides the magnitude of the correlations, |C(n)|, with the signal energy C₁(n), to generate normalized correlations, P(n). The correlations C(n), the signal energy C₁(n) and the normalized correlations P(n) may be written as follows:

$$\begin{matrix}C ( n ) = {\int }_{n}^{n + T} y ( t ) y * ( t - D ) ⅆ t ; & Equation ( 1 ) \\ {C}_{1} ( n ) = {\int }_{n}^{n + T} y ( t ) y * ( t ) ⅆ t ; \\ and & Equation ( 2 ) \\ P ( n ) = \frac{C ( n )}{{C}_{1} ( n )} . & Equation ( 3 )\end{matrix}$$

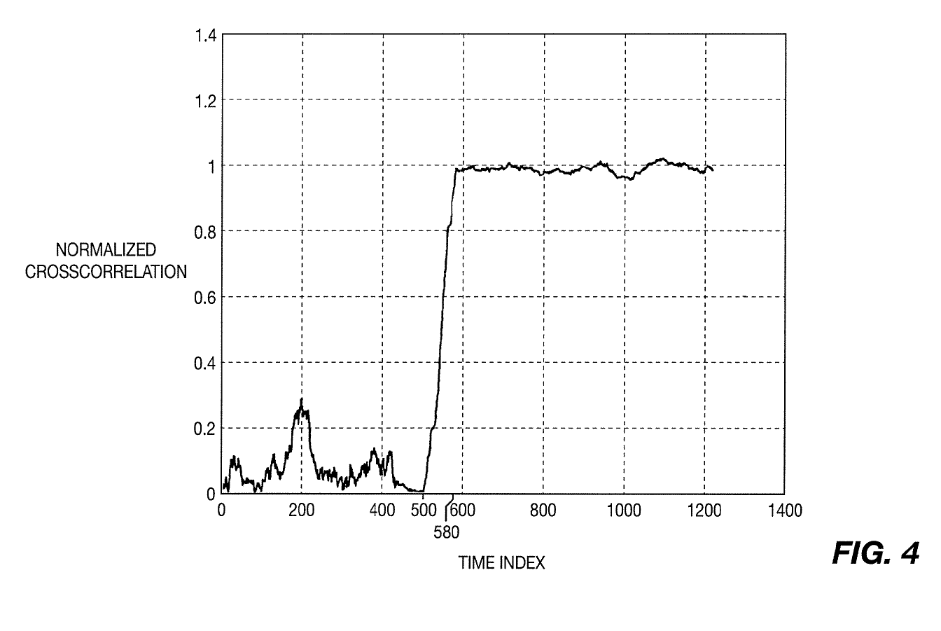

FIG. 4 shows normalized correlation values, P(n), calculated from the simulation. In the simulation, the integration interval is set to 0.8 μs, an SNR is set to 20 dB, and received signals are 5× over-sampled. In a conventional method, the normalized correlation, P(n), is searched over the time index, n. If P(n) is greater than or equal to a threshold, a signal detection is declared and the corresponding n is the starting point of the packet. The conventional method has a disadvantage that the threshold should be set differently depending on an SNR. The present invention alleviates this problem.

The present invention utilizes a differential detection method. At the starting point of the packet, n₁, the difference between P(n₁) and P(n₁+Tₛₗₒₜ) is maximum. As shown in FIG. 4, the normalized correlation rises from the minimum at a time index 500 to the maximum at a time index 580, which are separated by 80 samples, (i.e., 16 delay×5). Before the starting point of the packet, the normalized correlation values includes only noise and after the starting point of the packet the normalized correlation values increase to around one (1). Therefore, the difference of the two normalized correlation values P(n₁) and P(n₁+Tₛₗₒₜ) that are separated by the Tₛₗₒₜ is maximum at the starting point of the packet.

Referring back to FIG. 3, the difference calculator 340 includes a subtractor 346 which calculates a difference between P(n) and P(n+Tₛₗₒₜ) that are separated by a delay time, preferably Tₛₗₒₜ, (e.g., 16 samples), over n. Optionally, the difference calculator 340 may include two averaging units 342, 344 such that, before calculating the difference, the P(n₁) and P(n₁+Tₛₗₒₜ) are averaged over averaging periods L and L′, respectively, as follows:

$$S ( n ) = \frac{1}{L} {\sum }_{l = 0}^{L - 1} P ( n + D + l ) - \frac{1}{{L}^{′}} {\sum }_{{l}^{′} = 0}^{{L}^{′} - 1} P ( n - {l}^{′} ) . \qquad Equation ( 4 )$$

L and L′ may be same. The purpose of calculating an average is to reduce the effect of noise.

The comparator 350 compares the difference with a threshold and outputs a signal 352. If the difference is greater than or equal to the threshold, the signal 352 indicates a detection of the packet. If the difference is smaller than the threshold, the signal 352 indicates no detection of the packet.

The maximum identifier 360 identifies a local maximum for the difference, (or optionally S(n)), that are greater than or equal to the threshold. The maximum identifier 360 outputs a signal 362 indicating the point with the maximum value of the difference, (or optionally S(n)), as the starting point of the packet.

Although the features and elements of the present invention are described in the preferred embodiments in particular combinations, each feature or element can be used alone without the other features and elements of the preferred embodiments or in various combinations with or without other features and elements of the present invention. The methods provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any integrated circuit, and/or a state machine.

A processor in association with software may be used to implement a radio frequency transceiver for use in a WTRU, user equipment, terminal, base station, radio network controller, or any host computer. The WTRU may be used in conjunction with modules, implemented in hardware and/or software, such as a camera, a videocamera module, a videophone, a speakerphone, a vibration device, a speaker, a microphone, a television transceiver, a handsfree headset, a keyboard, a Bluetooth module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including a transmitting node and a receiving node wherein the transmitting node transmits a packet including a preamble which includes multiple repetition of a training sequence, a method for detecting the transmission of the packet, the method comprising:
detecting a signal;
correlating the detected signal with a delayed version of the detected signal which is delayed by a predetermined delay time to generate a sequence of correlations;
normalizing the correlations;
calculating a difference between a first normalized correlation and a second normalized correlation that are separated by the predetermined delay time; and
comparing the difference with a threshold, whereby transmission of the packet is detected based on the comparison.

2. The method of claim 1 wherein the first normalized correlation is averaged over a first averaging period and the second normalized correlation is averaged over a second averaging period, whereby the difference is calculated by subtracting the second normalized correlation from the first normalized correlation.

3. The method of claim 1 further comprising:
generating a signal which identifies a point with a maximum value of the calculated difference, whereby a packet synchronization is performed based on the identified point.

4. The method of claim 1 wherein the predetermined delay time is set to an integer multiple of a duration of the training sequence.

5. The method of claim 1 wherein the wireless communication system is an IEEE 802.11a system.

6. The method of claim 1 wherein the wireless communication system is an IEEE 802.11g system.

7. The method of claim 1 wherein the wireless communication system is an IEEE 802.11n system.

8. The method of claim 1 wherein the wireless communication system is a cellular communication system.

9. The method of claim 1 wherein the preamble includes ten (10) repetitions of a short training sequence.

10. In a wireless communication system including a transmitting node and a receiving node wherein the transmitting node transmits a packet including a preamble which includes multiple repetition of a training sequence, an apparatus for detecting the transmission of the packet, the apparatus comprising:
a correlation unit for calculating correlations of a detected signal and a delayed version of the detected signal that is delayed by a predetermined delay time;
a signal energy calculator for calculating a signal energy value;
a divider for dividing the correlations with the signal energy value to generate normalized correlations;
a difference calculator for calculating a difference between a first normalized correlation and a second normalized correlation that are separated by the predetermined delay time; and
a comparator for comparing the difference with a threshold, whereby transmission of the packet is detected based on the comparison.

11. The apparatus of claim 10 wherein the difference calculator is configured to average the first normalized correlation over a first averaging period and average the second normalized correlation over a second averaging period, whereby the difference is calculated by subtracting the second normalized correlation from the first normalized correlation.

12. The apparatus of claim 10 further comprising:
a maximum identifier for generating a signal which identifies a point with a maximum value of the calculated difference, whereby a packet synchronization is performed based on the point.

13. The apparatus of claim 10 wherein the predetermined delay time is set to an integer multiple of duration of the training sequence.

14. The apparatus of claim 10 wherein the wireless communication system is an IEEE 802.11a system.

15. The apparatus of claim 10 wherein the wireless communication system is an IEEE 802.11g system.

16. The apparatus of claim 10 wherein the wireless communication system is an IEEE 802.11n system.

17. The apparatus of claim 10 wherein the wireless communication system is a cellular communication system.

18. The apparatus of claim 10 wherein the preamble includes ten (10) repetitions of a short training sequence.
